(19) United States
(12) Patent Application Publication
(10) Pub. No.: US 2010/0283259 A1
(43) Pub. Date: Nov. 11, 2010

(54) WHEEL HOP GENERATOR MECHANISM

(76) Inventor: Sheng-Fu Hung, Dali City (TW)

Correspondence Address: EGBERT LAW OFFICES, 412 MAIN STREET, 7TH FLOOR, HOUSTON, TX, 77002, US

(21) Appl. No.: 12/436,681

(22) Filed: May 6, 2009

(51) Int. Cl. H02K 7/18

(52) U.S. Cl. 290/1 R

(57) ABSTRACT

The wheel hop generator mechanism includes a plurality of forced oil feeders, assembled between the axles and vehicle body. The forced oil feeders includes a cylinder and a telescopic cylinder block, and oil inlet check valves and oil outlet check valves are placed at the motion position of the piston of the cylinder corresponding to the telescopic cylinder block. An oil tank, used to accommodate the oil required for actuation of the forced oil feeders is linked by an oil pipeline to the oil inlet check valve and oil outlet check valve, forming a common oil circulation loop. An oil drive motor is assembled at a predefined section on the oil pipeline and has an oil inlet portion, oil discharge portion and power output axle. The power output axle is mated with a generator. Vehicles can be powered continuously to ensure better power generation effect.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a wheel generator mechanism, and more particularly to an innovative one which allows for power generation through wheel hop.

2. Description of Related Art Including Information Disclosed Under 37 CFR 1.97 and 37 CFR 1.98.

In view of the shortage of petroleum and worsening air pollution in the world, many countries have taken initiatives to develop and research alternative energy. Vehicles, in a wide range of applications, are a major contributing factor to rapid consumption of petroleum. For this reason, the leading auto manufacturers will make continuous efforts for R&D of new vehicles with alternative energy resources, such as: gas vehicles, diesel vehicles, hybrid vehicles, solar cars and hydrogen cars, with the purpose of reducing the petroleum consumption, or cutting down the environmental pollution and converting efficiently the energy resources with other alternatives.

Since alternative energies cannot fully replace petroleum with respect to efficiency, auxiliary power, such as hybrid fuel-electricity, is generally provided for this purpose. Further improvements shall be made to convert the kinetic energy generated by the vehicles into auxiliary power through a very simple structure and principle.

In order to utilize and save energy resources efficiently, many research efforts are already implemented to generate power automatically based on an inherent actuating property of products, such as: wheel rotation, wind blowing and hand-operated driving, etc.

However, there is still big room for improvement despite the aforementioned power generating structures. As for vehicle structures fitted with a damper, the wheel along with wheel axle may inevitably move up and down during the running process, in addition to wheel rotation; so such motion can be considered for power generation without interfering with running resistance.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the innovative structure of the present invention that the wheel hop generator mechanism comprises forced oil feeders, an oil tank, oil pipeline, oil drive motor and generator, power generation is made possible through wheel hop, thus providing users with another automatic generator mechanism and mode.

Furthermore, the oil circuits of the forced oil feeders are linked in tandem to drive individually the oil drive motors and link a generator for power supply, such that the vehicle can be powered continuously to ensure better power generation effect with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a top plan view of the assembled preferred embodiment of the generator mechanism of the present invention.

FIG. 2 shows a front elevation view of the present invention showing the status when the forced oil feeders are assembled between the wheel axle and vehicle body.

FIG. 3 shows a schematic view of the operation of the present invention when the forced oil feeders are extended.

FIG. 4 shows a schematic view of the operation of the present invention when the forced oil feeders are shortened.

FIG. 5 shows a schematic view of the operation of the present invention when the oil pipeline is actuated during wheel hop.

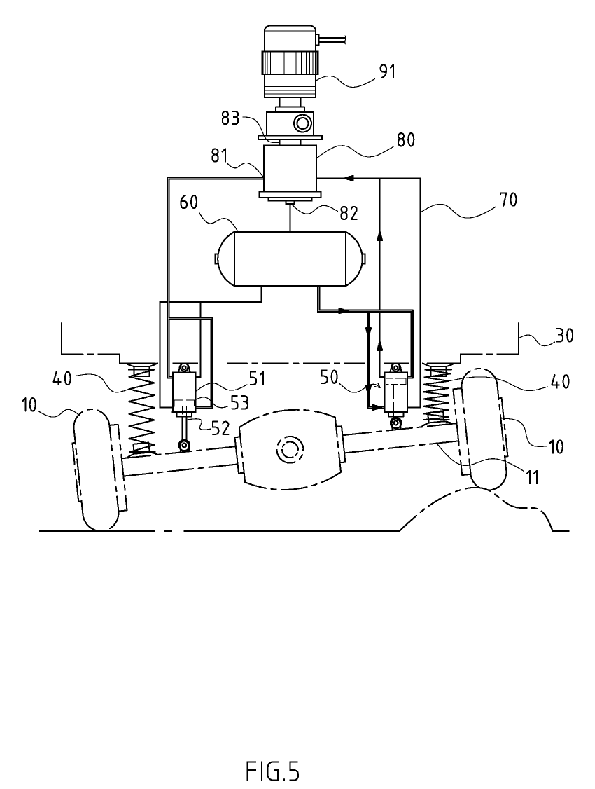

### DETAILED DESCRIPTION OF THE INVENTION

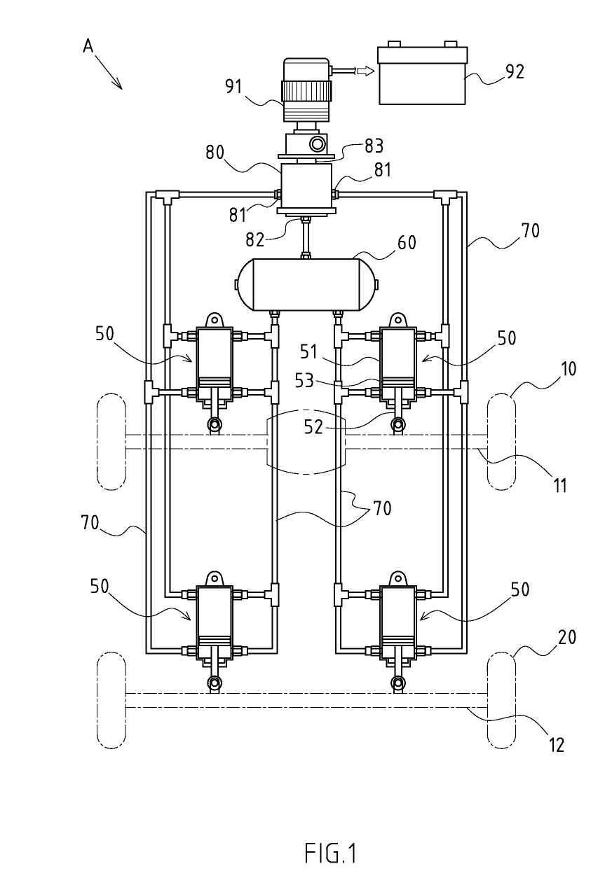

FIGS. 1-3 depict preferred embodiments of a wheel hop generator mechanism of the present invention. The embodiments are provided for only explanatory objectives with respect to the patent claims.

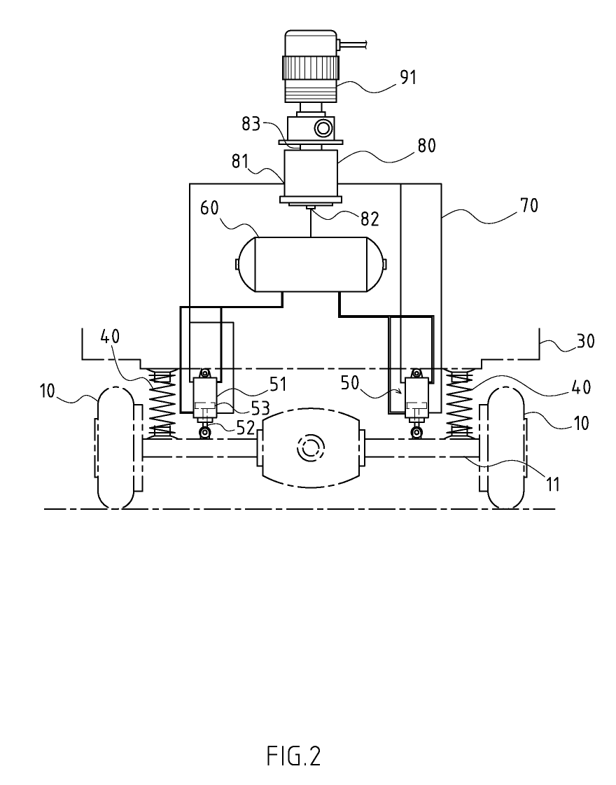

The generator mechanism A can be used for power generation through the displacement of the vehicle generated by wheel hop. Referring to FIG. 1, the wheel comprises a front wheel set 10 and rear wheel set 20, both of which are separately assembled onto both ends of a front axle 11 and a rear axle 12. A spring damper 40 is arranged between the front and rear axles 11, 12 and vehicle body 30 (shown in FIG. 2).

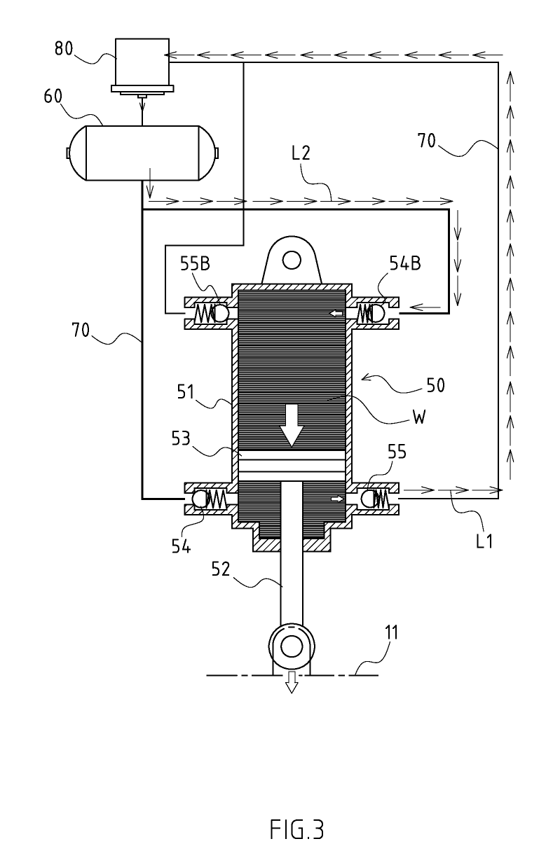

The generator mechanism A comprises a plurality of forced oil feeders 50, which are assembled separately between the front/rear axles 11, 12 and vehicle body 30. The forced oil feeders 50 of the preferred embodiment are arranged in pairs alternatively between the front and rear axles 11, 12 (shown in FIG. 1). A forced oil feeder 50 is composed of a cylinder 51 and a telescopic cylinder block 52 with a piston 53. Oil inlet check valves 54, 54B and oil outlet check valves 55, 55B (shown in FIG. 3) are placed at the motion position of the piston 53 of the cylinder 51 corresponding to the telescopic cylinder block 52, so that oil can flow along the predefined path.

An oil tank 60 is used to accommodate the oil required for actuation of the forced oil feeders 50 and store the returned oil.

An oil pipeline 70 is used to link the oil tank 60 with the oil inlet check valves 54 and oil outlet check valves 55 of the forced oil feeders 50, thus forming a common oil circulation loop.

An oil drive motor 80 is assembled at a predefined section on the oil pipeline 70. The oil drive motor 80 consists of an oil inlet portion 81, oil discharge portion 82 and power output axle 83, of which the oil inlet portion 81 is linked with the oil pipeline 70, whilst the oil discharge portion 82 is linked with the oil tank 60.

A generator 91 is driven by the oil drive motor 80 for power generation. The electricity generated by the generator 91 can be transferred to a storage battery 92 (shown in FIG. 1).

Based on above-specified structures, the present invention is operated as follows:

Referring to FIG. 2 (along with FIG. 1), when the vehicle body 30 is driven by the front and rear wheel sets 10, 20 during rotary running, the front and rear wheel sets 10, 20 along with the front and rear axles 11, 12 allow for flexible damping based on the flexible support of the damper 40.

The generator mechanism A is actuated when the telescopic cylinder block 52 of the forced oil feeders 50 moves up and down with the fluctuation of the front and rear axles 11, 12.

Referring to FIG. 3, when the telescopic cylinder block 52 of the forced oil feeder 50 is extended under the guide of the front axle 11, oil W compressed downwards by the piston 53 will be exported through the oil outlet check valve 55 at bottom of the cylinder 51, and then transferred via oil pipeline 70 to the oil drive motor 80 (shown by arrow L1) for driving purposes. At the same time, oil W of oil tank 60 will be guided into the expanded space over the piston 53 through the oil inlet check valve 54B at top of the cylinder 51 (shown by arrow L2), enabling oil W at both sides of the piston 53 within the cylinder 51 to be compensated mutually for a balanced state.

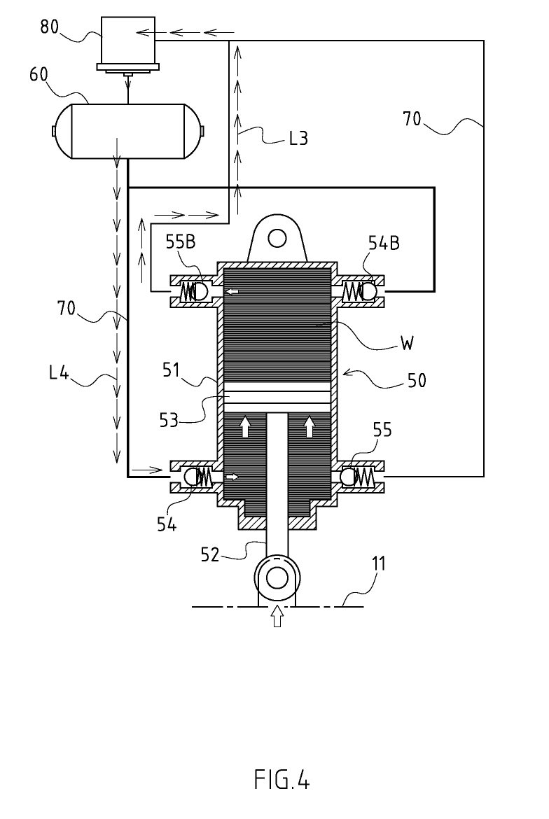

Referring also to FIG. 4, when the telescopic cylinder block 52 of the forced oil feeder 50 is shortened under the guide of the front axle 11, oil W compressed upwards by the piston 53 will be exported through the oil outlet check valve 55B at top of the cylinder 51 (shown by arrow L3), and then transferred via oil pipeline 70 to the oil drive motor 80 for driving purpose. At the same time, oil W of oil tank 60 will be guided into the expanded space under the piston 53 through the oil inlet check valve 54 at bottom of the cylinder 51 (shown by arrow L4), enabling oil W at both sides of the piston 53 within the cylinder 51 to be compensated mutually for a balanced state.

Then, the generator 91 is actuated by the oil drive motor 80 to generate electricity. As mentioned above, when the forced oil feeders 50 are operated, the oil drive motor 80 can be driven by the oil pressure no matter the telescopic cylinder block 52 is extended or shortened, thereby avoiding the problems occurred from insufficient driving force and frequency.

1. A wheel hop generator mechanism, for power generation from a wheel hop through displacement of a vehicle with at least a wheel set of wheels, assembled onto both ends of an axle, and a spring damper arranged between the axle and vehicle body, the generator mechanism comprising:
a plurality of forced oil feeders, assembled between axles and the vehicle body, each forced oil feeder being comprised of a cylinder and a telescopic cylinder block with a piston, said cylinder having oil inlet check valves and oil outlet check valves placed at a motion position of the piston of the cylinder corresponding to the telescopic cylinder block;
an oil tank means to accommodate oil required for actuation of the forced oil feeders and store the returned oil;
an oil pipeline means to link the oil tank with the oil inlet check valve and oil outlet check valve of the forced oil feeder, forming a common oil circulation loop;
an oil drive motor, being assembled at a predefined section on the oil pipeline and being comprised of an oil inlet portion, oil discharge portion and power output axle, said oil inlet portion being linked with the oil pipeline, said oil discharge portion being linked with the oil tank;
a generator, driven by the oil drive motor for power generation.

2. The generator mechanism as defined in claim 1, wherein the forced oil feeders are arranged in pairs alternatively between the front and rear axles.
